(19) United States
(12) Patent Application Publication
(10) Pub. No.: US 2015/0205767 A1
(43) Pub. Date: Jul. 23, 2015

(54) LINK APPEARANCE FORMATTING BASED ON TARGET CONTENT

(71) Applicant: Google Inc., Mountain View, CA (US)

(72) Inventors: Zoltan STEKKELPAK, Sunnyvale, CA (US); Artem CHETVERYKOV, Mountain View, CA (US)

(73) Assignee: Google Inc., Mountain View, CA (US)

(21) Appl. No.: 13/674,904

(22) Filed: Nov. 12, 2012

(51) Int. Cl. G06F 17/22; G06F 17/30; G06F 17/21

(52) U.S. Cl. CPC G06F 17/2235; G06F 17/211; G06F 17/3089

(57) ABSTRACT

Methods for formatting an appearance of a link based on linked content are provided. In one aspect, a method includes receiving a request to load, for display, a document including a link to another document, and receiving an identifier of at least one of a geographic region associated with the other document, a language associated with the other document, an age appropriateness of the other document, interactions with the other document, whether content of the other document is intended to disrupt computer operation, a time associated with the other document, and a user's interest profile for content identified in the other document. The method also includes formatting an appearance of the link to the other document based on the identifier. Systems and machine-readable media are also provided.

### BACKGROUND

1. Field

The present disclosure generally relates to the transmission of data over a network, and more particularly to the use of a computing device to display data communicated over a network.

2. Description of the Related Art

Links and other references to data a user can follow (e.g., hyperlinks) usually point to a new document or a specific element within a document. Hyperlinks, for example, point to web addresses such as Uniform Resource Locators (URL). Hyperlinks commonly appear by way of hypertext (or “anchor text”), which is text intended to describe the link. For example, a hyperlink to a web address “wwx.classicmovies.com” can appear as the hypertext “Link to Classic Movies.” In many cases the hypertext for a hyperlink is a copy of the web address to which the hyperlink points. Although intended to describe a document being pointed to, hypertext does not provide any indication as to the utility, quality, or any other characteristic of the actual content of the document being pointed to. For example, although the hypertext may be “Link to Classic Movies” for the web address “wwx.classicmovies.com”, the web site wwx.classicmovies.com may actually consist of content that has no relation to classic movies but instead contains malicious software to disrupt computer operation.

### SUMMARY

According to one embodiment of the present disclosure, a computer-implemented method for formatting an appearance of a link based on linked content is provided. The method includes receiving a request to load, for display, a document including a link to another document, and receiving an identifier of at least one of a geographic region associated with the other document, a language associated with the other document, an age appropriateness of the other document, interactions with the other document, whether content of the other document is intended to disrupt computer operation, a time associated with the other document, and a user's interest profile for content identified in the other document. The method also includes formatting an appearance of the link to the other document based on the identifier.

According to another embodiment of the present disclosure, a system for formatting an appearance of a link based on linked content is provided. The system includes a memory and a processor. The memory includes a document for display, and the document includes a link to another document. The processor is configured to execute instructions to receive a request to load, for display, the document, and receive an identifier of at least one of a geographic region associated with the other document, a language associated with the other document, an age appropriateness of the other document, interactions with the other document, whether content of the other document is intended to disrupt computer operation, a time associated with the other document, and a user's interest profile for content identified in the other document. The processor is configured to execute instructions to format an appearance of the link to the other document based on the identifier. The link includes text for display on the document, and wherein formatting the appearance of the link includes changing at least one of a color of the text, a color displayed behind the text, a size of the text, font used for the text, changing a typeface for the text, providing animation associated with the text, or providing a visual indicator near the text.

According to a further embodiment of the present disclosure, a machine-readable storage medium includes machine-readable instructions for causing a processor to execute a method for formatting an appearance of a link based on linked content is provided. The method includes receiving a request to load, for display, a web page document including a link to another web page document, and receiving an identifier of at least one of a geographic region associated with the other document, a language associated with the other document, an age appropriateness of the other document, interactions with the other document, whether content of the other document is intended to disrupt computer operation, a time associated with the other document, and a user's interest profile for content identified in the other document. The method also includes formatting an appearance of the link to the other document based on the identifier. The link includes anchor text for display on the document. Formatting the appearance of the anchor text includes changing at least one of a color of the anchor text, a color displayed behind the anchor text, a size of the anchor text, font used for the anchor text, changing a typeface for the anchor text, providing animation associated with the anchor text, or providing a visual indicator near the anchor text.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example architecture for formatting an appearance of a link based on linked content.

FIG. 2 is a block diagram illustrating an example client and server from the architecture of FIG. 1 according to certain aspects of the disclosure.

FIG. 3 illustrates an example process for formatting an appearance of a link based on linked content using the example client of FIG. 2.

FIG. 4 is an example illustration associated with the example process of FIG. 3.

FIG. 5 is a block diagram illustrating an example computer system with which the clients and server of FIG. 2 can be implemented.

### DETAILED DESCRIPTION

In the following detailed description, numerous specific details are set forth to provide a full understanding of the present disclosure. It will be apparent, however, to one ordinarily skilled in the art that the embodiments of the present disclosure may be practiced without some of these specific details. In other instances, well-known structures and techniques have not been shown in detail so as not to obscure the disclosure.

The disclosed system formats the appearance of links (e.g., hypertext or anchor text) on a document that point to another document. The text or other formatted content can be displayed with other content in the document, including formatting content appearing in hover text or a box (e.g., pop up box). Some of the factors considered by the disclosed system when formatting the appearance of the link include the geographic region associated with the document (e.g., language, country), the appropriateness of content of the document (e.g., not safe for children), interactions with the document (e.g., how many endorsements or comments the document has received, how many other documents link to the document, etc.), user behavior associated with the document (e.g., how long a user on average views the document), whether the document is known to include malicious software, interactions with the document by other users associated with the user that is linked to the document, a time or date associated with the document, and a user's interest profile for content identified in the document. In certain aspects, data for the considered factors may be stored locally on a client device loading the document for display to pre-cache the information by predicting a user's future intent to load the document for display in order to expedite the formatting of a link on the document. The formatting of the appearance of a link may occur at the time a document including the link is loaded or when a portion of the document including the link appears on a display for a user.

Although many examples provided herein describe a user's information being stored in memory, each user must grant explicit permission for such user information to be stored. The explicit permission may be granted using privacy controls integrated into the disclosed system. If requested user information includes demographic information, then the demographic information is aggregated on a group basis and not by individual user. Each user is provided notice that such user information will be stored with such explicit consent, and each user may at any time end having the user information stored, and may delete the stored user information. The stored user information may be encrypted to protect user security.

The user can at any time delete the user information from memory and/or opt out of having the user information stored in memory. Additionally, the user can, at any time, adjust appropriate privacy settings to selectively limit the types of user information stored in memory, or select the memory in which the user information is stored (e.g., locally on the user's device as opposed to remotely a server). In many examples, the user information does not include and/or share the specific identification of the user (e.g., the user's name) unless otherwise specifically provided or directed by the user.

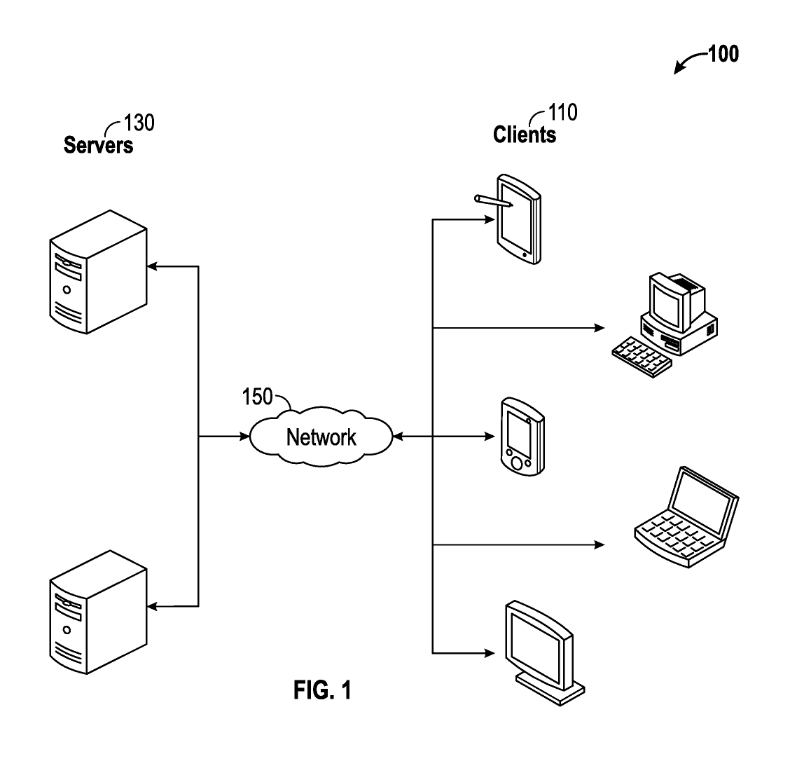

FIG. 1 illustrates an example architecture 100 for formatting an appearance of a link based on linked content. The architecture 100 includes servers 130 and clients 110 connected over a network 150.

The disclosed system, which may be embodied in an executable application, is configured to run on each of the clients 110. The clients 110 can be, for example, desktop computers, mobile computers, tablet computers (e.g., including e-book readers), mobile devices (e.g., a smartphone or PDA), set top boxes (e.g., for a television), video game consoles, or any other devices having appropriate processor, memory, and communications capabilities. The clients 110 may each be configured to connect to servers 130 over network 150 in order to link to one or many documents on a server 130. The servers 130 can be any device having an appropriate processor, memory, and communications capability for hosting linked documents and a document identification repository for storing data regarding the linked documents. The linked documents and the document identification repository can be on the same server 130 or different servers 130. The network 150 can include, for example, any one or more of a personal area network (PAN), a local area network (LAN), a campus area network (CAN), a metropolitan area network (MAN), a wide area network (WAN), a broadband network (BBN), the Internet, and the like. Further, the network 150 can include, but is not limited to, any one or more of the following network topologies, including a bus network, a star network, a ring network, a mesh network, a star-bus network, tree or hierarchical network, and the like.

The application, which can be, for example, a web browser, is configured to load a document on a client 110 for display. The loaded document that is displayed includes a link to another document, such as a document on a server 130. The link to the document on the server 130 can be represented in the loaded document as text, such as anchor text. The application is configured to obtain identification information on the document on the server 130, such as by analyzing the content of the document on the server 130 or by obtaining such information from the document identification repository on the server 130. The obtained information may indicate a predicted usefulness of the document on the server 130 to a user, the quality of the content of the document on the server 130, availability of the document on the server 130, or other factors. Based on the obtained information on the document on the server 130, the application is configured to format the appearance of the link, such as the appearance of the anchor text, in the loaded document so as to provide a user viewing the loaded document with information to assist the user with determining whether the user would like to activate the link to view and load the document on the server 130. The text or other formatted content may appear with other content in the document, including formatting content appearing in hover text or a box (e.g., pop up box). The formatting may take place when the document is initially loaded on the client 110, or when a portion of a loaded document appears within a viewing region or “viewport” of the client 110.

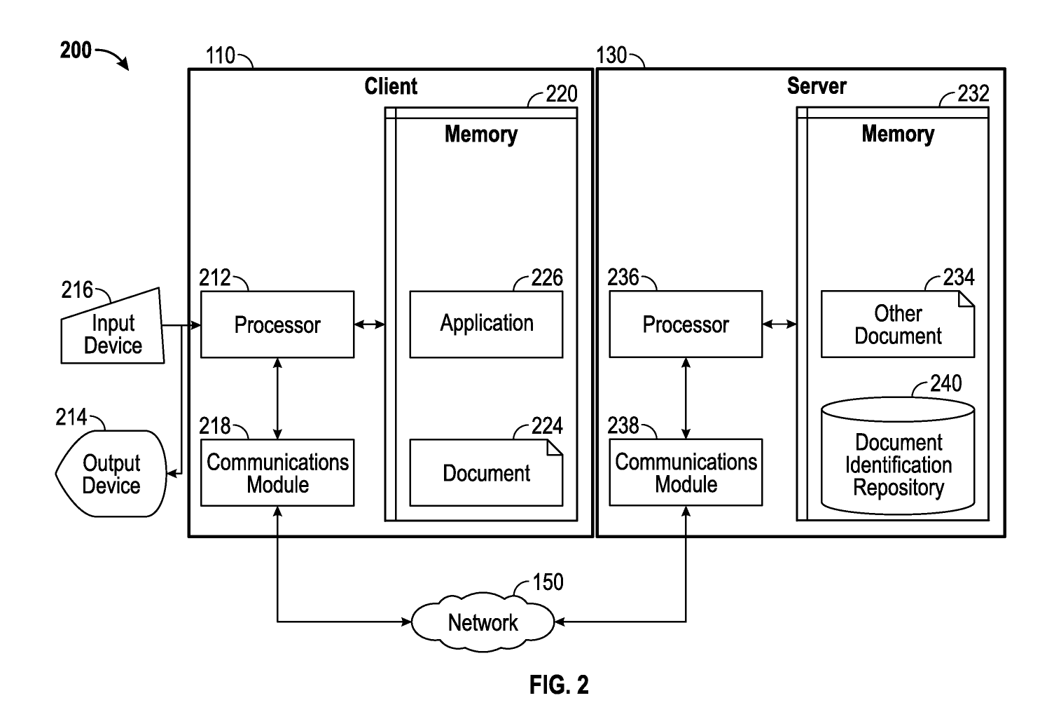

FIG. 2 is a block diagram 200 illustrating an example server 130 and client 110 in the architecture 100 of FIG. 1 according to certain aspects of the disclosure. The client 110 and the server 130 are connected over the network 150 via respective communications modules 218 and 238. The communications modules 218 and 238 are configured to interface with the network 150 to send and receive information, such as data, requests, responses, and commands to other devices on the network. The communications modules 218 and 238 can be, for example, modems or Ethernet cards.

The client 110 includes a processor 212, the communications module 218, and a memory 220. The memory 220 of the client 110 includes an application 226, such as a web browser, document editor, or other document viewing application configured for viewing a document 224 in memory 220. The application 226 may also be an application add-on, such as a web browser extension or toolbar. The memory 220 of the client 110 also includes the document 224 to be loaded in the application 226. The document 224 includes a link to another document 234 in the memory 232 of a sever 130. The processor 212 of the client 110 is configured by the application 226 to request a copy of the other document 234 from the processor 236 on the server 130 over the network 150 via respective communications modules 218 and 238 of the client 110 and server 130. Although the other document 234 is illustrated as being resident in the memory 232 of the server 130, the other document 234 may instead or additionally reside in the memory 220 of the client 110.

The client 110 also includes an input device 216, such as a keyboard or mouse, and an output device 214, such as a display. The processor 212 of the client 110 is configured to execute instructions, such as instructions physically coded into the processor 212, instructions received from software in memory 232, or a combination of both. For example, the processor 212 of the client 110 executes instructions to format an appearance of a link (e.g., in the document 224) based on linked content (e.g., of the other document 234). Specifically, the processor 212 of the client 110 executes instructions from the application 226 causing the processor 212 to receive a request to load, for display, a document 224 including a link to the other document 234. The processor 212 receives information (an “identifier”) about the other document 234. The identifier provides an identification of the content of the other document 234.

The identifier can indicate a geographic region associated with the other document 234 or a language associated with the other document 234. For example, the identifier can indicate that the other document 234 is hosted on a server 130 in a foreign region (and may therefore include content restrictions) or that the other document 234 is primarily in a language that is foreign to the language of the application 226.

The identifier can also indicate an age appropriateness of the other document 234. For example, the identifier can indicate whether the other document 234 contains content that is considered inappropriate for minors, offensive, hateful, or detrimental for viewing by a certain audience.

The identifier can further indicate interactions by users with the other document 234. For example, the identifier can indicate whether the other document 234 is commonly linked to by yet other documents, whether the other document 234 is commonly selected for viewing in response to a search query, or an average duration of time a user spends viewing the other document 234.

The identifier can also indicate whether content of the other document 234 is intended to disrupt computer operation. For example, the identifier can indicate whether the other document 234 includes or is otherwise linked to malicious software used or created to disrupt computer operation, gather sensitive information, or gain unauthorized access to the client 110. In these instances, the other document 234 may be identified as including a computer virus, worm, trojan horse, spyware, or adware. The identifier can also indicate whether the other document 234 is a phishing document for attempting to acquire information or money such as usernames, passwords, and credit card details by masquerading as a trustworthy entity.

The identifier can further indicate a time associated with the other document 234. For example, the identifier can indicate a date the other document 234 was created, a date the other document 234 was uploaded or published, or an expiration date associated with content of the other document 234.

The identifier can yet further indicate a user's interest profile for content identified in the other document 234. For example, if a user viewing the document 224 on the client 110 has provided information on the user's content preferences (e.g., language preferences, content subject matter preferences, restrictions, etc.), then the user's content preferences may be considered when formatting the appearance of the link to the other document 234.

In certain aspects, the identifier may further include an indicator of a reading level of the other document 234. For example, the identifier can indicate whether the other document 234 includes content that is considered a difficult for comprehension by a certain type of user. The identifier may be, for example, a comprehension difficulty score, such as a Flesh Reading Ease Score (FRES) calculated using the Flesh-Kincaid readability test. Other test may also be used to determine a reading level of the other document 234.

In certain aspects, the identifier may yet further include an indicator of an authorship reliability of the other document 234. For example, the identifier can indicate whether the identified author (whether individual or entity) of the other document 234 is considered trustworthy or has meets certain standards.

In certain aspects, the identifier may also include an indicator of a page load time relative to a requesting user's geographic location of the other document 234. For example, the identifier can indicate that the other document 234 may require a significant amount of time to load on the client 110 due to the other document 234 being hosted on a server 130 that is geographically distant from the client 110 or that the server 130 suffers from uptime reliability issues.

In certain aspects, the identifier may further include an indicator of an availability of the other document 234. For example, the identifier can indicate whether the other document 234 is currently available for loading from the server 130, whether the other document 234 is corrupted and cannot be displayed, or whether the server 130 hosting the other document 234 is not available.

In certain aspects, the identifier may yet further include an indicator of whether the other document 234 is formatted for display on a mobile device. For example, where the application 226 is running on a client 110 that is a mobile device, the identifier can indicate whether the other document 234 is formatted for display on a mobile device such as the client 110.

In certain aspects, the identifier may also include an indicator of at least one type of multimedia content identified by the other document 234. For example, if the other document 234 includes content that is a video, audio, animation, or interactive interface (e.g., using a multimedia platform), or is itself content that is a video, audio, animation, or interactive interface, the type of the content can be indicated by the identifier.

In certain aspects, the identifier may further include an indicator of user behavior associated with the other document 234. The user behavior can be, for example, an amount of time a user spends viewing the other document 234 or a number of clicks or link activations a user engages with the other document, or a number of comments or endorsements of the other document 234 from users.

In certain aspects where the request to load is received by a user of the client 110, the identifier may further include an indicator of behavior associated with the other document 234 by other users associated with the user. For example, the other users may be affiliated with the user in a social network or in a contacts database.

The identifier may be obtained from the document identification repository 240 on the server. The document identification repository 240 is configured to store information on documents configured for display in the application. The document identification repository 240 can collect the information by analyzing each of the documents. The document identification repository 240 can include a continuously updated or static list of parameters to every document analyzed by the document identification repository 240, such as in a search index.

With the explicit permission of users, the document identification repository 240 can also collect the information based on user behavior and/or user analysis of the documents. In certain aspects, all or some of the data from the document identification repository 240 can be stored on the client 110 based on a prediction that a user of the client 110 will load the document 224 for display. The data from the document identification repository 240 is loaded for storage on the client 110 prior to receiving the request to load the document 224 on the client. Thus, a link to the other document 234 included in the document 224 can be formatted on the client 110 immediately when the document 224 is loaded for display and without reference to the document identification repository 240 on the server 130.

The identifier may also be obtained directly by the application 226 as a result of an analysis by the application 226. For example, the application 226 when loading the other document 234 from the server 130 can analyze certain portions of the document including, for example, meta elements or displayed text.

The processor 212 of the client 110 is configured to execute instructions to format an appearance of the link to the other document 234 on the server 130 based on the identifier. For example, where the appearance of the link to the other document 234 includes text, the appearance of the link to the other document 234 can be formatted to change at least one of font color, font size, font type, font typeface (e.g., italics, bold, underlining, strike through, shadow, outline, emboss, or engrave), background color, adding or removing an icon or other visual indicator (e.g., an exclamation point), or adding or removing an animation effect (e.g., flashing or fading). In certain aspects, the anchor text, link label, link text, or link title of the link to the other document 234 is formatted. In certain other aspects, other visual indicators of a link such as a hyperlink are formatted. In yet certain other aspects, for a link having anchor text that is different from the link itself, both the anchor text and the link (e.g., a URL address for the link) may be formatted.

A legend or other reference may be provided by the application 226, such as in the document 224, for explaining any various different formatting changes to links in the document 224.

In certain aspects, the appearance of the link to the other document 234 is formatted for display when the other document 234 is loaded and rendered for display from the server 130 on the client. Thus, the appearance of the link is formatted regardless of whether the link to the other document 234 ever appears within the viewport of the client 110.

In certain other aspects, the appearance of the link to the other document 234 is formatted for display when a portion of the other document 234 that includes the link appears within a viewport of the client 110. Thus, the appearance of a link is not formatted if the link to the other document 234 does not appear within the viewport of the client 110.

In certain aspects, when the other document 234 is not currently available (e.g., to be loaded onto the client 110), the link to the other document 234 is not provided for display on the document 224. For example, if the server 130 is not available due to a connection between the server 130 and the network 150 being lost, then links to documents on the server 130 may either not be provided for display or formatted to reduce visibility of the links (e.g., by graying out text).

The application 226 is illustrated in FIG. 2 as residing on the client 110. In embodiments where the application resides on the client 110, such as in an application 226 that is a web browser, the application 226 can, at download and/or rendering time of the other document 234, send a request to the document identification repository 240 on the server 130 for the identifier for the other document 234. The request may include a list of links on the document 224 that point to documents such as the other document 234, preference information for a user of the client 110 (e.g., a language setting of the application 226, information about the application 226, user content preferences, user age, etc.), and a location of the client 110. The document identification repository 240 then provides identifiers and/or other information for the listed links that may be applied by the application 226 to format hyperlink or anchor text.

In certain embodiments, the application 226 may reside on the server 130 in place of or in addition to residing on the client 110. The server 130 may receive a request from the client 110 to load the document 224. The request may include the preference information for the user of the client 110. Based on the preference information, the processor 236 of the server 130 obtains information from the document identification repository 240 on the other document 234 linked to by the document 224. The server 130 can then provide the document 224 to the user with formatting of links based on the preference information.

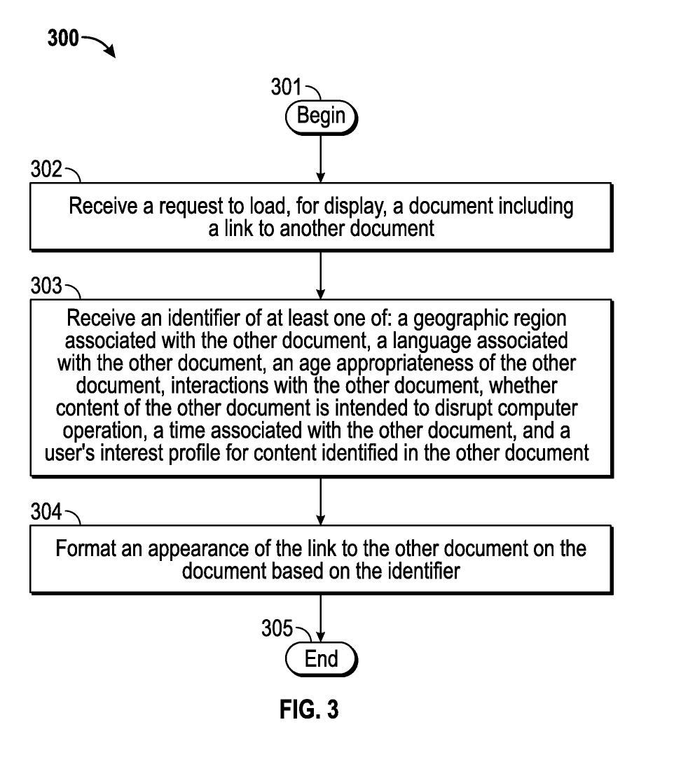

FIG. 3 illustrates an example process 300 for formatting an appearance of a link based on linked content using the example client 110 of FIG. 2. While FIG. 3 is described with reference to FIG. 2, it should be noted that the process steps of FIG. 3 may be performed by other systems. The process 300 begins by proceeding from beginning step 301 when the application 226 is loaded on the client 110 to step 302 when a request to load, for display, a document 224 including a link to another document 234 is received (e.g., by the application 226 from a user of the client 110). In step 303, an identifier of the other document 234 is received, for example, by the application 226 over the network 150 from the document identification repository 240 on the server 130. The identifier can be for at least one of a geographic region associated with the other document 234, a language associated with the other document 234, an age appropriateness of the other document 234, interactions with the other document 234, whether content of the other document 234 is intended to disrupt computer operation, a time associated with the other document 234, and a user's interest profile for content identified in the other document 234. In step 304, an appearance of the link to the other document 234 on the document 224 is formatted based on the identifier. The process 300 ends in step 305.

FIG. 3 set forth an example process 300 for formatting an appearance of a link based on linked content using the example client 110 and server 130 of FIG. 2. An example will now be described using the example process 300 of FIG. 3, a client 110 that is a desktop computer, an application 226 that is a web browser, a document 224 that is a web page having links to four other documents 234 that include content that is of high utility, low utility, includes malicious content, and includes a high level of user activity, respectively.

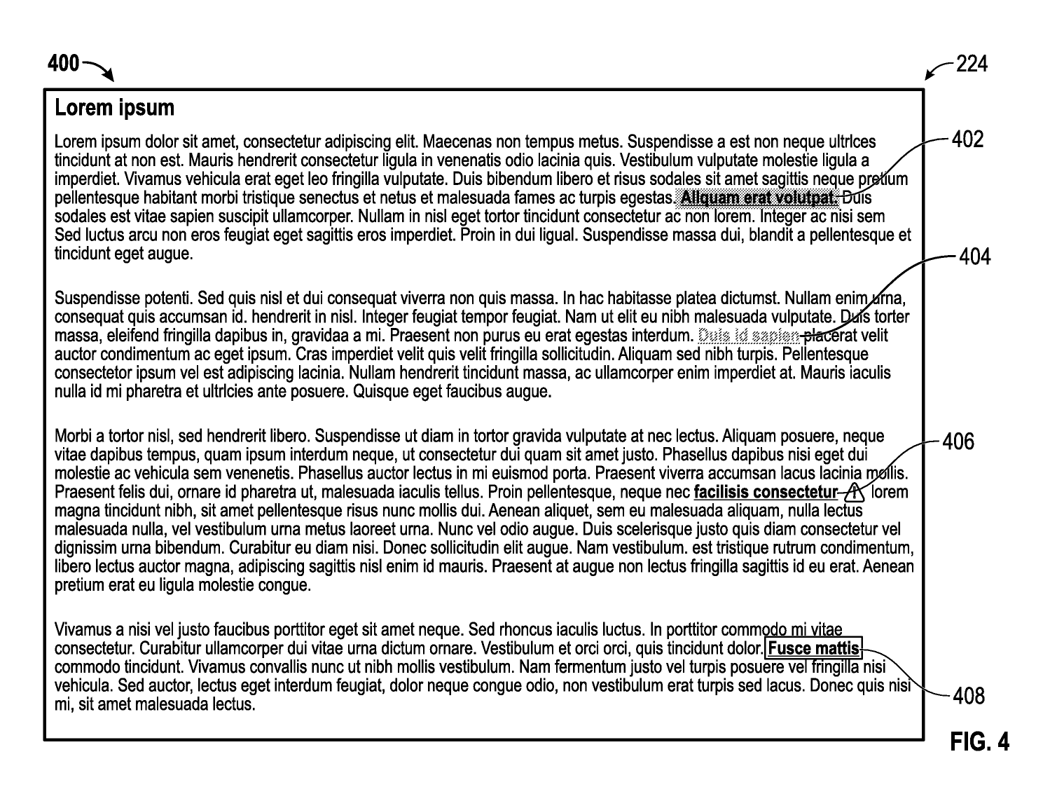

The process 300 begins by proceeding from beginning step 301 when a user opens the web browser 226 is loaded on the desktop computer 110. In step 302, the user requests to load a web page 224 in the web browser 226. FIG. 4 is an example illustration 400 of the web page 224 as viewed in the web browser 226. The web page 224 includes links 402, 404, 406, and 408 to four other web pages. In step 303, an identifier of the four other web pages is received by the web browser 226 over the network 150 from the document identification repository 240 on the server 130 in response to a request from the web browser 226. The identifier indicates that the web page linked to by the first link 402 includes content that is of high utility and the web page linked to by the second link 404 includes content that is of low utility. The identifier also indicates that the web page linked to by the third link 406 includes malicious content and the web page linked to by the fourth link 408 includes content that has a high level of user activity.

In step 304, the appearance of anchor text for each of the links 402, 404, 406, and 408 in the web page 224 is formatted based on the identifier. Specifically, the first link 402 is formatted to be bold with a shaded background to indicate that the web page linked to by the first link 402 includes content that is of high utility. The second link 404 is formatted to be grayed out to indicate that the web page linked to by the second link 404 includes content that is of low utility. The third link 406 is formatted to include an alert icon to indicate that the web page linked to by the third link 406 includes malicious content. The fourth link 408 is formatted to include a box circling the anchor text to indicate that the web page linked to by the fourth link 408 includes content that has a high level of user social activity (e.g., comments). Although the illustrated formatting is displayed in black and white, the formatting may also use different colors to format the appearance of each of the links 402, 404, 406, and 408. The process 300 ends in step 305.

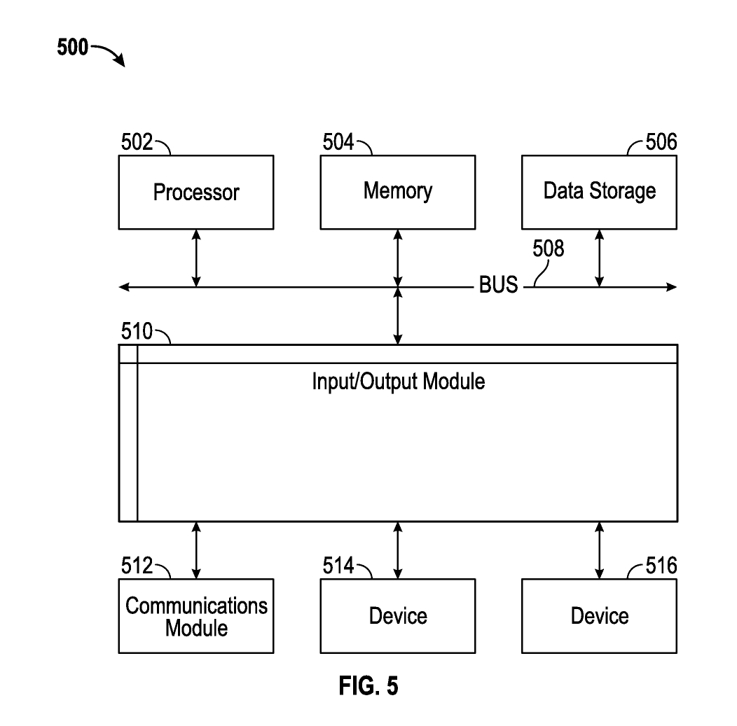

FIG. 5 is a block diagram illustrating an example computer system 500 with which the client 110 and server 130 of FIG. 2 can be implemented. In certain aspects, the computer system 500 may be implemented using hardware or a combination of software and hardware, either in a dedicated server, or integrated into another entity, or distributed across multiple entities.

Computer system 500 (e.g., client 110 and server 130) includes a bus 508 or other communication mechanism for communicating information, and a processor 502 (e.g., processor 212 and 236) coupled with bus 508 for processing information. By way of example, the computer system 500 may be implemented with one or more processors 502. Processor 502 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 500 can include, in addition to hardware, code that creates an execution environment for the computer program in question, e.g., code that constitutes processor firmware, a protocol stack, a database management system, an operating system, or a combination of one or more of them stored in an included memory 504 (e.g., memory 120), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 508 for storing information and instructions to be executed by processor 502. The processor 502 and the memory 504 can be supplemented by, or incorporated in, special purpose logic circuitry.

The instructions may be stored in the memory 504 and implemented in one or more computer program products, i.e., one or more modules of computer program instructions encoded on a computer readable medium for execution by, or to control the operation of, the computer system 500, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, embeddable languages, and xml-based languages. Memory 504 may also be used for storing temporary variable or other intermediate information during execution of instructions to be executed by processor 502.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 500 further includes a data storage device 506 such as a magnetic disk or optical disk, coupled to bus 508 for storing information and instructions. Computer system 500 may be coupled via input/output module 510 to various devices. The input/output module 510 can be any input/output module. Example input/output modules 510 include data ports such as USB ports. The input/output module 510 is configured to connect to a communications module 512. Example communications modules 512 (e.g., 218 and 238) include networking interface cards, such as Ethernet cards and modems. In certain aspects, the input/output module 510 is configured to connect to a plurality of devices, such as an input device 514 (e.g., input device 216) and/or an output device 516 (e.g., output device 214). Example input devices 514 include a keyboard and a pointing device, e.g., a mouse or a trackball, by which a user can provide input to the computer system 500. Other kinds of input devices 514 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Example output devices 516 include display devices, such as a LED (light emitting diode), CRT (cathode ray tube), or LCD (liquid crystal display) screen, for displaying information to the user.

According to one aspect of the present disclosure, the client 110 and server 130 can be implemented using a computer system 500 in response to processor 502 executing one or more sequences of one or more instructions contained in memory 504. Such instructions may be read into memory 504 from another machine-readable medium, such as data storage device 506. Execution of the sequences of instructions contained in main memory 504 causes processor 502 to perform the process steps described herein. One or more processors in a multi-processing arrangement may also be employed to execute the sequences of instructions contained in memory 504. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network (e.g., network 150) can include, for example, any one or more of a personal area network (PAN), a local area network (LAN), a campus area network (CAN), a metropolitan area network (MAN), a wide area network (WAN), a broadband network (BBN), the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computing system 500 can include clients and servers. A client and server are generally remote from each other and typically interact through a communication network. The relationship of client and server arises by virtue of computer programs running on the respective computers and having a client-server relationship to each other. Computer system 500 can be, for example, and without limitation, a desktop computer, laptop computer, or tablet computer. Computer system 500 can also be embedded in another device, for example, and without limitation, a mobile telephone, a personal digital assistant (PDA), a mobile audio player, a Global Positioning System (GPS) receiver, a video game console, and/or a television set top box.

The term “machine-readable storage medium” or “computer readable medium” as used herein refers to any medium or media that participates in providing instructions or data to processor 502 for execution. Such a medium may take many forms, including, but not limited to, non-volatile media, volatile media, and transmission media. Non-volatile media include, for example, optical disks, magnetic disks, or flash memory, such as data storage device 506. Volatile media include dynamic memory, such as memory 504. Transmission media include coaxial cables, copper wire, and fiber optics, including the wires that comprise bus 508. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Furthermore, to the extent that the term “include,” “have,” or the like is used in the description or the claims, such term is intended to be inclusive in a manner similar to the term “comprise” as “comprise” is interpreted when employed as a transitional word in a claim.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The subject matter of this specification has been described in terms of particular aspects, but other aspects can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims.

These and other implementations are within the scope of the following claims.

1. A computer-implemented method for formatting an appearance of a link based on linked content, the method comprising:
receiving a request to load, for display, a document including a link to another document;
receiving an identifier of at least one of a geographic region associated with the other document, a language associated with the other document, an age appropriateness of the other document, endorsements of, comments about, or links to the other document, a time of creation, uploading, publication, or expiration associated with the other document, and a user's interest profile for content identified in the other document; and
formatting an appearance of the link to the other document based on the identifier.

2. The computer-implemented method of claim 1, wherein the identifier further comprises an indicator of whether content of the other document is intended to disrupt computer operation, a reading level, an authorship reliability, a page load time relative to a requesting user's geographic location, and an availability of the other document.

3. The computer-implemented method of claim 1, wherein the request is received on a mobile device, and wherein the identifier further comprises an indicator of whether the other document is formatted for display on a mobile device.

4. The computer-implemented method of claim 1, wherein the identifier further comprises an indicator of at least one type of multimedia content identified by the other document.

5. The computer-implemented method of claim 1, wherein the identifier further comprises an indicator of user behavior associated with the other document.

6. The computer-implemented method of claim 5, wherein the user behavior comprises an amount of time a user spends viewing the other document.

7. The computer-implemented method of claim 1, wherein the request is received from a user, and the identifier comprises an indicator of behavior associated with the other document by other users associated with the user.

8. The computer-implemented method of claim 1, wherein the request is received on a device, and wherein formatting the appearance of the link to the other document occurs when the link appears within a viewport of the device.

9. The computer-implemented method of claim 1, wherein the request is received from a user of a device, the method further comprising predicting a request from the user to load the document prior to receiving the request to load the document, and receiving the identifier in response to predicting the request from the user to load the document.

10. The computer-implemented method of claim 1, wherein the link comprises text for display on the document, and wherein formatting the appearance of the link comprises changing at least one of a color of the text, a color displayed behind the text, a size of the text, font used for the text, changing a typeface for the text, providing animation associated with the text, or providing a visual indicator near the text.

11. The computer-implemented method of claim 1, wherein formatting the appearance of the link to the other document comprises not providing the link for display on the document when the other document is not currently available.

12. A system for formatting an appearance of a link based on linked content, the system comprising:
a memory comprising a document for display, the document including a link to another document;
a processor configured to execute instructions to:
receive a request to load, for display, the document;
receive an identifier of at least one of a geographic region associated with the other document, a language associated with the other document, an age appropriateness of the other document, endorsements of, comments about, or links to the other document, a time of creation, uploading, publication, or expiration associated with the other document, and a user's interest profile for content identified in the other document; and
format an appearance of the link to the other document based on the identifier,
wherein the link comprises text for display on the document, and wherein formatting the appearance of the link comprises changing at least one of a color of the text, a color displayed behind the text, a size of the text, font used for the text, changing a typeface for the text, providing animation associated with the text, or providing a visual indicator near the text.

13. The system of claim 12, wherein the identifier further comprises an indicator of whether content of the other document is intended to disrupt computer operation, a reading level, an authorship reliability, a page load time relative to a requesting user's geographic location, and an availability of the other document.

14. The system of claim 12, wherein the request is received on a mobile device, and wherein the identifier further comprises an indicator of whether the other document is formatted for display on a mobile device.

15. The system of claim 12, wherein the identifier further comprises an indicator of at least one type of multimedia content identified by the other document or an indicator of user behavior associated with the other document, the indicator of the user behavior comprising an amount of time a user has spent viewing the other document.

16. The system of claim 12, wherein the request is received from a user, and the identifier comprises an indicator of behavior associated with the other document by other users associated with the user.

17. The system of claim 12, wherein the request is received on a device, and wherein formatting the appearance of the link to the other document occurs when the link appears within a viewport of the device.

18. The system of claim 12, wherein the request is received from a user of a device, the system further comprising the processor being configured to predict a request from the user to load the document prior to receiving the request to load the document, and receive the identifier in response to predicting the request from the user to load the document.

19. The system of claim 12, wherein formatting the appearance of the link to the other document comprises not providing the link for display on the document when the other document is not currently available.

20. A machine-readable storage medium comprising machine-readable instructions for causing a processor to execute a method for formatting an appearance of a link based on linked content, the method comprising:
receiving a request to load, for display, a web page document including a link to another web page document;
receiving an identifier of at least one of a geographic region associated with the other document, a language associated with the other document, an age appropriateness of the other document, endorsements of, comments about, or links to the other document, a time of creation, uploading, publication, or expiration associated with the other document, and a user's interest profile for content identified in the other document; and
formatting an appearance of the link to the other document based on the identifier,
wherein the link comprises anchor text for display on the document, and wherein formatting the appearance of the anchor text comprises changing at least one of a color of the anchor text, a color displayed behind the anchor text, a size of the anchor text, font used for the anchor text, changing a typeface for the anchor text, providing animation associated with the anchor text, or providing a visual indicator near the anchor text.
